(19) United States
(12) Patent Application Publication
(10) Pub. No.: US 2018/0080639 A1
(43) Pub. Date: Mar. 22, 2018

(54) ELONGATED ROADWAY LUMINAIRE STRUCTURE

(71) Applicant: GE Lighting Solutions, LLC, East Cleveland, OH (US)

(72) Inventors: Tamas PAPAI, Nagykanizsa (HU); Emese GORGENYI, Budapest (HU)

(21) Appl. No.: 15/273,306

(22) Filed: Sep. 22, 2016

(51) Int. Cl. F21V 21/116; F21S 8/08

(52) U.S. Cl. CPC F21V 21/116; F21W 2131/103; F21S 8/086

(57) ABSTRACT

A roadway luminaire includes a base unit having opposing bent edges parallel to a longitudinal axis of the base unit and an aperture through the base unit configured to accept a mounting pole, a driver housing attached to the base unit, and a cover door hingedly attached to the driver housing. The base unit, driver housing, and cover door defining an interior volume of the roadway luminaire. A coupler element is attached to a surface of the base unit within the interior volume, the coupler element configured to compressably engage a section of the mounting pole; and the coupler element configured to provide rotation of the roadway luminaire in at least two degrees of freedom with respect to a longitudinal axis of the mounting pole.

### BACKGROUND

Municipalities often provide roadway luminaires suspended from a pole along a roadside to illuminate the road. Roadway lighting serves as an important safety feature for busy streets and highways where visibility is essential. Roadway lights provide illumination that can help drivers be aware of their surroundings and provide well-illuminated safety for pedestrians.

For safety reasons intersections and sharp curves could have a higher concentration of roadway luminaires than, for example, straight sections of a highway. A well-designed lighting plan takes into consideration driver's eye fatigue, headlight illumination, and road features (e.g., inside curve, outside curve, blind spots, pedestrian crossings, etc.). For consistent lighting, the roadway luminaire could be placed at regular intervals.

Conventional roadway luminaires include die cast components. Such a conventional luminaire can include a die cast coupler that mounts the roadway luminaire to the pole. This die cast coupler limits the range of pole diameters to which the luminaire could be mounted. Additionally, the components of a die cast roadway luminaire can require a long lead-time for production. The weight of a die cast roadway luminaire mounted at the top of a pole creates a large moment-of-force that also drives the physical construction and expense of the lighting pole itself.

### BRIEF DESCRIPTION OF THE DRAWINGS

FIG. 1A depicts an isometric top view of an elongated roadway luminaire in accordance with embodiments;

FIG. 1B depicts an isometric bottom view of the elongated roadway luminaire of FIG. 1;

FIG. 1C depicts an exploded view of the elongated roadway luminaire of FIGS. 1A-1B; and

FIG. 2 depicts a coupler element of the elongated roadway luminaire in accordance with embodiments.

### DETAILED DESCRIPTION

Embodying systems and methods provide a low production cost outdoor luminaire that includes a base of edge-bent aluminum sheet metal which carries a stainless steel coupler, driver electronics for the light source, and a plastic housing. The aluminum sheet metal has edges bent on its long sides that give rigidity to the construction.

In accordance with embodiments, the coupler is formed from sheet metal components, and provides versatile coupling to a wide range of pole diameters. The roadway luminaire includes a plastic housing and plastic covers. The housing, covers, and base are assembled together to provide intrusion protection against dust and water that is in compliance with the IP66 ingress protection standard for protection of the luminaire's internal electronics (e.g., driver electronics and optical light source boards). Internal access is provided by one of the covers being hingedly connected to the aluminum sheet metal part for installation and wiring.

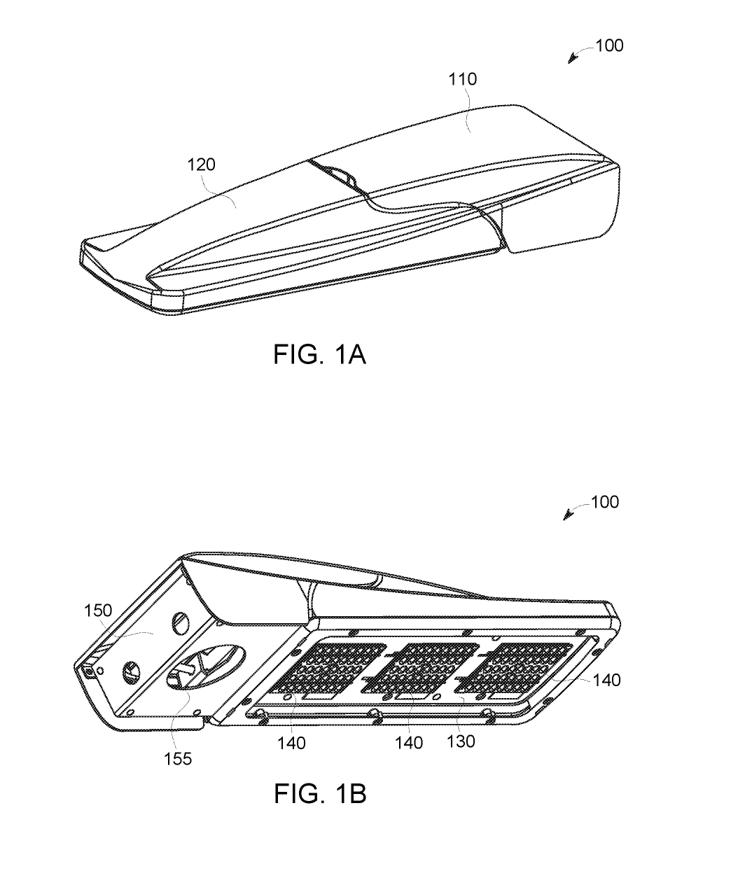

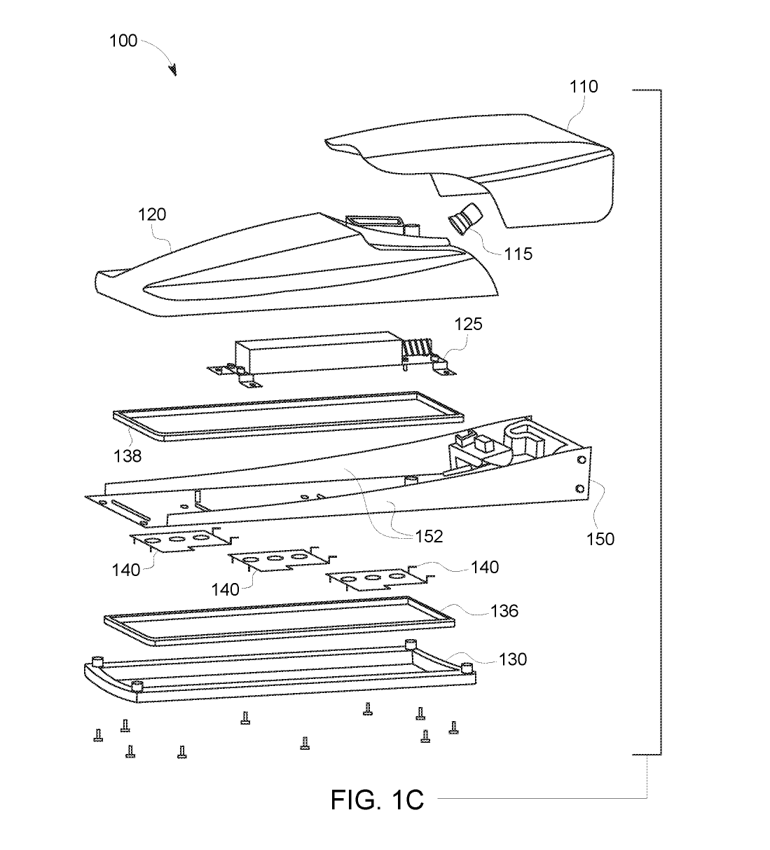

FIGS. 1A-1B depicts isometric (respectively top and bottom) views of elongated roadway luminaire 100 in accordance with embodiments. Elongated luminaire 100 includes cover door 110, driver housing 120, optical cover 130, optical assemblies 140, and base unit 150.

FIG. 1C depicts an exploded view of elongated roadway luminaire 100 in accordance with embodiments. At least one hinge 115 can attach cover 110 to driver housing 120. Driver electronics 125 can be mounted to base unit 150 within the luminaire.

Frame member 136, 138 can be positioned on opposing sides of base unit 150 to act as gaskets for attachment of optical cover 130 to the roadway luminaire. These gaskets can prevent dirt, water, and other substances from intruding into the interior of the luminaire. In some implementations frame members 136, 138 can be made of rubber, but other sealant materials are also within contemplation of this disclosure. In accordance with some implementations, optical cover 130 can be transparent, translucent, or a diffuser element.

In accordance with embodiments, base unit 150 is formed from sheet metal material. Opposing edges 152 of the base unit are bent along a longitudinal axis of the base unit to provide structural integrity to the base unit. Other components of the luminaire, for example, cover door 110, driver housing 120 can be formed from injected molded plastic (e.g., polycarbonate).

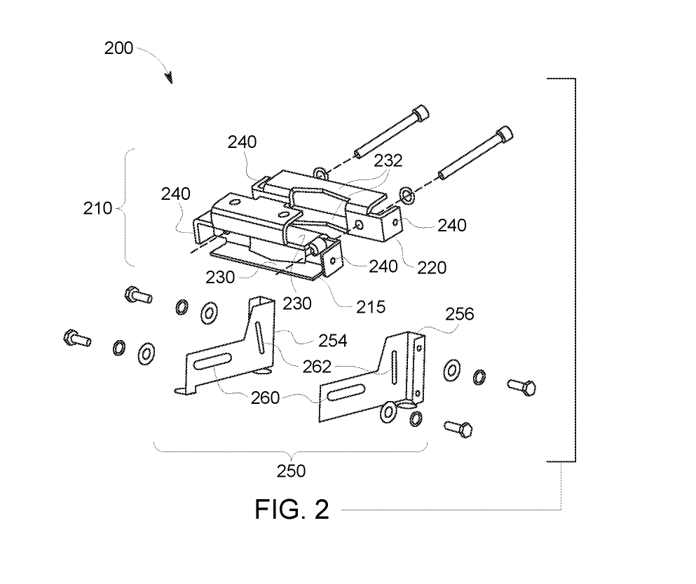

FIG. 2 depicts coupler element 200 of the elongated roadway luminaire in accordance with embodiments. Coupler element 200 includes pole bracket 210 and mount bracket 250 that are slideably connected. Pole bracket 210 includes a pair of clamp brackets 215, 220. The clamp brackets are joined together by fasteners (e.g., bolts), which draw the two clamp brackets together. Clamp brackets each include inner-facing surfaces 230, 232. When drawn together these inner-facing arcuate surfaces define an aperture through which a light pole can be extended. Tightening of the fasteners compressably clamps the roadway luminaire to the pole.

Mount bracket 250 includes a pair of L-shaped brackets 254, 256 having about orthogonal legs. Each leg of the L-shaped bracket includes slotted aperture 260, 262 that are parallel to a longitudinal axis of their respective leg. Pole bracket 210 is fastened to mount bracket 250 by fasteners (e.g., bolts) that pass through the respective aperture 260, 262 into corresponding tabs 240 on each of the clamp brackets 215, 220.

The slotted apertures permit roadway luminaire 100 to be pivotably mounted to the pole via clamp brackets 215, 220. The slotted aperture provide movement of the roadway luminaire in at least two degrees of freedom (e.g., tilt and rotation) so that the luminaire can move continuously about ±15° in each of these freedoms with respect to a longitudinal perpendicular axis of the pole.

In accordance with embodiments, the components of pole bracket 210 and mount bracket 250 can be made of stainless steel to provide structural rigidity and reliability to the mount. In accordance with the depicted embodiment of FIG. 2, the aperture defined by drawing together clamp brackets 215, 220 is circular. This circular aperture can have a variable diameter of about 42 mm 76 mm. However, embodiments are not so limited and other diameter ranges are within the scope of this disclosure.

The aperture shape defined by drawing together clamps brackets 215, 220 need not be circular (e.g., other cross sectional shapes can include oval, polygon, etc.). Adjustment of the profile of inner-facing surfaces 230, 232 can be altered from arcuate (depicted) to accommodate these other pole cross sections.

In accordance with embodiments, base unit 150 can include aperture 155 (FIG. 1B) that accepts the mounting pole into an interior of the roadway luminaire to reach pole bracket 210. The aluminum and stainless steel components are thermally conductive and draw heat away from driver electronics 125 and optical boards 140.

In accordance with embodiments, the coupler brackets can be set discretely for different pole diameters (e.g., about 30, 42, 60, or 76 mm). In accordance with implementations, the configuration of the roadway luminaire composed of sheet metal and injection molded parts can have a weight of below about 5 kg. The low-weight of the luminaire decreases the moment-of-force stress on the mounting pole. This low weight also is attractive for weight-critical installations—for example on bridges and other spans.

Manufacture and assembly of the roadway luminaire is easily achieved by using the sheet metal and injection molded components disclosed above. This manufacturing approach reduces lead-time production startup and reduces non-recurring tool costs by eliminating the long-lead time, and expensive, molds needed for the die-cast components of a conventional roadway luminaire. In accordance with embodiments, the roadway luminaire is lightweight with high structural rigidity, reliability, and thermal mass. Embodying designs allow rapid, customized products to meet customer specifications without incurring large tooling costs associated with die-cast components.

Although described herein are specific hardware and methods, note that any number of other configurations may be provided in accordance with embodiments of the invention. Thus, while there have been shown, described, and pointed out fundamental novel features of the invention, it will be understood that various omissions, substitutions, and changes in the form and details of the illustrated embodiments, and in their operation, may be made by those skilled in the art without departing from the spirit and scope of the invention. Substitutions of elements from one embodiment to another are also fully intended and contemplated. The invention is defined solely with regard to the claims appended hereto, and equivalents of the recitations therein.

1. A roadway luminaire comprising:
a base unit having a longitudinal axis including opposing bent edges parallel to the longitudinal axis and an aperture through the base unit configured to accept a mounting pole;
a driver housing attached to the base unit;
a cover door hingedly attached to the driver housing;
the base unit, driver housing, and cover door defining an interior volume of the roadway luminaire;
a coupler element attached to a surface of the base unit within the interior volume, the coupler element configured to compressably engage a section of the mounting pole; and
the coupler element configured to provide rotation of the roadway luminaire in at least two degrees of freedom with respect to a longitudinal axis of the mounting pole.

2. The roadway luminaire of claim 1, the at least two degrees of freedom including tilt and rotation.

3. The roadway luminaire of claim 1, the coupler element including a pole bracket and a mount bracket.

4. The roadway luminaire of claim 3, the pole bracket including a pair of clamping brackets each including an inner-facing surface, the inner-facing surfaces shaped to form an aperture configured to accommodate a cross section of the mounting pole.

5. The roadway luminaire of claim 4, the aperture being circular in shape.

6. The roadway luminaire of claim 5, the circular aperture having an adjustable diameter in the range of about 42-76 mm.

7. The roadway luminaire of claim 5, the circular aperture having a diameter selected from a group including 30, 42, 60, and 76 mm.

8. A roadway luminaire comprising:
a base unit having a longitudinal axis including opposing bent edges parallel to the longitudinal axis and an aperture through the base unit configured to accept a mounting pole;
a driver housing attached to the base unit;
a cover door hingedly attached to the driver housing;
the base unit, driver housing, and cover door defining an interior volume of the roadway luminaire;
a coupler element attached to a surface of the base unit within the interior volume, the coupler element configured to compressably engage a section of the mounting pole, the coupler element including a pole bracket and a mount bracket; and
the coupler element configured to provide rotation of the roadway luminaire in at least two degrees of freedom with respect to a longitudinal axis of the mounting pole;
wherein the mount bracket including a pair of L-shaped brackets:
each L-shaped bracket having two about orthogonal legs;
each orthogonal leg having a slotted aperture parallel to a longitudinal axis of the respective orthogonal leg.

9. The roadway luminaire of claim 3, the pole bracket slideably attached to the mount bracket.

10. The roadway luminaire of claim 1, the base unit formed from sheet metal.

11. The roadway luminaire of claim 1, the driver housing and cover door each formed from an injection molded plastic.
